(19) United States
(12) Patent Application Publication
(10) Pub. No.: US 2011/0100975 A1
(43) Pub. Date: May 5, 2011

(54) CARRIER FOR HEATING AND KEEPING WARM

(75) Inventors: Wu-Han Liu, Miaoli County (TW); Wei-Tien Hsiao, Hsinchu County (TW); Mao-Shin Liu, Hsinchu City (TW); Zhong-Ren Wu, Taichung County (TW); Ming-Sheng Leu, Hsinchu County (TW); Chang-Chih Hsu, Hsinchu City (TW)

(73) Assignee: INDUSTRIAL TECHNOLOGY RESEARCH INSTITUTE, Hsinchu (TW)

(21) Appl. No.: 12/917,485

(22) Filed: Nov. 2, 2010

(30) Foreign Application Priority Data
Nov. 3, 2009 (TW) 98137311

(51) Int. Cl. A21B 1/52

(52) U.S. Cl. 219/387

(57) ABSTRACT

A carrier for heating and keeping warm used for directly carrying food to-be kept warm is provided. The carrier for heating and keeping warm includes a carrier and at least a high melt point-electric heating alloy pattern. The carrier has a first surface and a second surface opposite to the first surface. The food is suitable for being directly placed on the first surface. A material of the second surface is ceramics or glass so that the second surface 114 and the first surface 112 can respectively have a characteristic of ceramic or glass. The high melt point-electric heating alloy pattern is coated on the second surface. A resistance of the high melt point-electric heating alloy pattern is substantially 0.5 ohm to 50 ohm, and a melt point of the high melt point-electric heating alloy pattern is equal to or higher than 1100° C.

### CROSS-REFERENCE TO RELATED APPLICATION

This application claims the priority benefit of Taiwan application serial no. 98137311, filed on Nov. 3, 2009. The entirety of the above-mentioned patent application is hereby incorporated by reference herein and made a part of this specification.

### BACKGROUND

1. Field of the Disclosure

The disclosure relates to a carrier and relates to a carrier for heating and keeping warm.

2. Description of Related Art

A warm-keeping container is generally a kitchen cooking utensil, and a function thereof is to keep food in a warm state. Generally, a preferable warm-keeping effect of the warm-keeping container is to keep a temperature of the food around 50-80° C. Due to the warm-keeping function of the warm-keeping container, when people fetches the food, the food can still be maintained at a certain temperature instead of in a cold state, so as to avoid affecting health and appetite of people.

A commonly used warm-keeping approach includes a passive design (for example, a vacuum cup) and an active design (for example, an electric saucepan). In the passive warm-keeping design, a container formed by multiple layers of heat insulation materials is generally used to isolate external air, so that internal of the container is not liable to exchange temperature with external through conduction or convection. However, according to the passive design, temperature loss still exists due to thermal radiation and minor conduction. In other words, the passive design cannot maintain the food in a warm state for a long time, and a thickness of an insulation layer has to be very thick to achieve the warm-keeping effect, which may cause problems of excessively large size of the container and excessively small containing space.

In the active design, alternating current (AC) electricity is used to heat a device having an electric heating characteristic such as a nickel-chromium wire, etc. to indirectly heat a container. Moreover, according to the active design, a temperature sensor and a temperature control device are further used. A heating curve is controlled by a mutual feedback of the temperature sensor and the temperature control device, so as to maintain the required temperature. Such indirect heating method has a shortage of low efficiency, and configuration of the temperature sensor and the temperature control device increases complexity of the container.

### SUMMARY OF THE DISCLOSURE

The disclosure is directed to a carrier for heating and keeping warm, which can directly heat through electricity, so as to achieve a warm-keeping function.

The disclosure provides a carrier for heating and keeping warm used for directly carrying food to be kept warm. The carrier for heating and keeping warm includes a carrier and at least a high melt point-electric heating alloy pattern. The carrier has a first surface and a second surface opposite to the first surface. The food is suitable for being directly placed on the first surface. A material of the second surface is ceramics or glass. The high melt point-electric heating alloy pattern is coated on the second surface. A resistance of the high melt point-electric heating alloy pattern is substantially 0.5 ohm to 50 ohm, and a melt point of the high melt point-electric heating alloy pattern is equal to or higher than 1100° C.

According to the above descriptions, in the disclosure, the high melt point-electric heating alloy pattern is coated on a surface of the carrier according to a coating method. The high melt point-electric heating alloy pattern can be heated after being powered, and the high melt point-electric heating alloy pattern has a specific resistance, so as to reach a specific temperature after being powered. In this way, the carrier for heating and keeping warm of the disclosure can directly heat to achieve a warm-keeping effect by directly powering the high melt point-electric heating alloy pattern. Moreover, the high melt point-electric heating alloy pattern is fabricated according to a thermal spray method without using a high-temperature sintering method, so as to avoid damaging the carrier due to the high-temperature sintering process.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating a carrier for heating and keeping warm according to an exemplary embodiment of the disclosure.

FIG. 2A and FIG. 2B are electron microscope photographs of coating layers respectively formed on substrates through a thermal spray method and a sintering method.

FIG. 3A is a top view of a high melt point-electric heating alloy pattern according to an exemplary embodiment of the disclosure.

FIG. 3B is a partial cross-sectional view of a carrier for heating and keeping warm according to an exemplary embodiment of the disclosure.

FIG. 4 is a partial cross-sectional view of a carrier for heating and keeping warm according to another exemplary embodiment of the disclosure.

FIG. 5 is a diagram illustrating a heating curve of a powered carrier for heating and keeping warm according to an exemplary embodiment of the disclosure, in which a horizontal axis represents time, and a vertical axis represents temperatures.

FIG. 6 is a diagram illustrating heating distributions of water and bottom of a powered carrier for heating and keeping warm in a water-carrying state according to an exemplary embodiment of the disclosure, in which a horizontal axis represents time, and a vertical axis represents temperatures.

### DETAILED DESCRIPTION OF DISCLOSED EMBODIMENTS

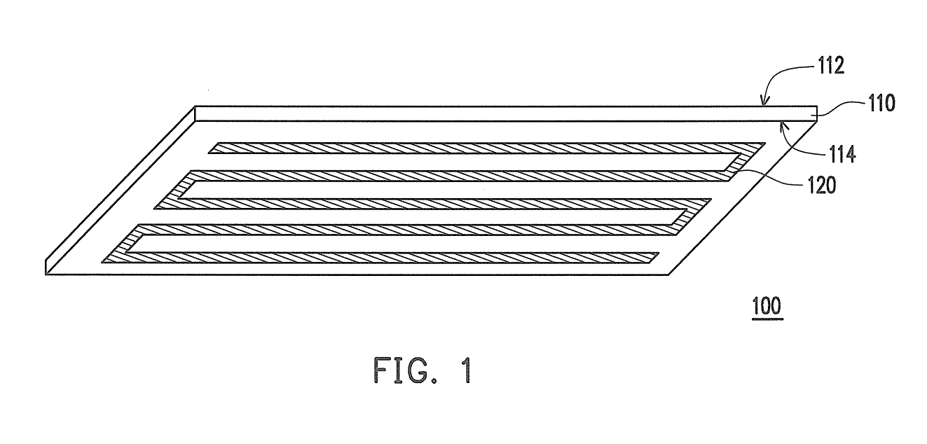

FIG. 1 is a schematic diagram illustrating a carrier for heating and keeping warm according to an exemplary embodiment of the disclosure. Referring to FIG. 1, the carrier for heating and keeping warm 100 includes a carrier 110 and at least a high melt point-electric heating alloy pattern 120. The carrier 110 has a first surface 112 and a second surface 114 opposite to the first surface 112. A material of the carrier 110 is ceramics or glass so that the second surface 114 and the first surface 112 can respectively have a characteristic of ceramic or glass. The high melt point-electric heating alloy pattern 120 is coated on the second surface 114. Moreover, the carrier for heating and keeping wane 100 is suitable for directly carrying food (not shown) to be kept warm, namely, the food can be directly placed on the first surface 112. In the present exemplary embodiment, the carrier 110 is, for example, a platform, though in other embodiments, the carrier 110 can be a dish, a bowl, a pan, a cup or other containers capable of directly carrying food.

The high melt point-electric heating alloy pattern 120 can be only coated on the bottom of the carrier 110. If the carrier 110 is fabricated by a transparent material such as glass, etc., it may have a transparent characteristic, so that a user can easily see the food in the carrier for heating and keeping warm 100, which facilitates utilization convenience. Certainly, such design can also avoid a situation that a pattern designed on the carrier 110 such as a dish, a bowl, a pan or a cup etc. is shielded by the high melt point-electric heating alloy pattern 120, so as to achieve an advantage of aesthetics.

In a conventional design, an additional heating device is generally used to indirectly heat the food in the pan, the bowl, the dish, or the cup. However, the high melt point-electric heating alloy pattern 120 can convert electricity into heat energy after being powered, so as to heat the food in the carrier 110 or the carrier 110 itself. Namely, according to the design of the present exemplary embodiment, the heat energy generated by the high melt point-electric heating alloy pattern 120 on the pan, the bowl, the dish, or the cup can be directly used to heat the food. Therefore, the present exemplary embodiment provides the carrier for heating and keeping warm 100 capable of directly carrying and heating the food, so as to achieve a high utilization convenience.

Moreover, according to a design of the conventional heating device, a material having the electric heating characteristic is formed on the device through a sintering process. In order to avoid damaging the device due to the high-temperature sintering process, the material having the electric heating characteristic has to have a characteristic of low melt point. For example, the electric heating material having the characteristic of low melt point is, for example, aluminium, silver or copper, etc. Actually, in order to reduce a fabrication temperature required by the sintering process, a low melt point material such as lead has to be added in theses electric heating materials. Therefore, when the conventional heating device is used to directly heat the food, the food is liable to be contaminated, which may also cause environmental pollution.

In the present exemplary embodiment, the high melt point-electric heating alloy pattern 120 is coated on the second surface 114 according to a thermal spray method. The commonly used thermal spray method includes a plasma spray method, an arc spray method, a flame thermal method or a high-speed flame spray method. The thermal spray method is to directly spray melted metal powder or metal bar on the second surface 114 to form the required high melt point-electric heating alloy pattern 120.

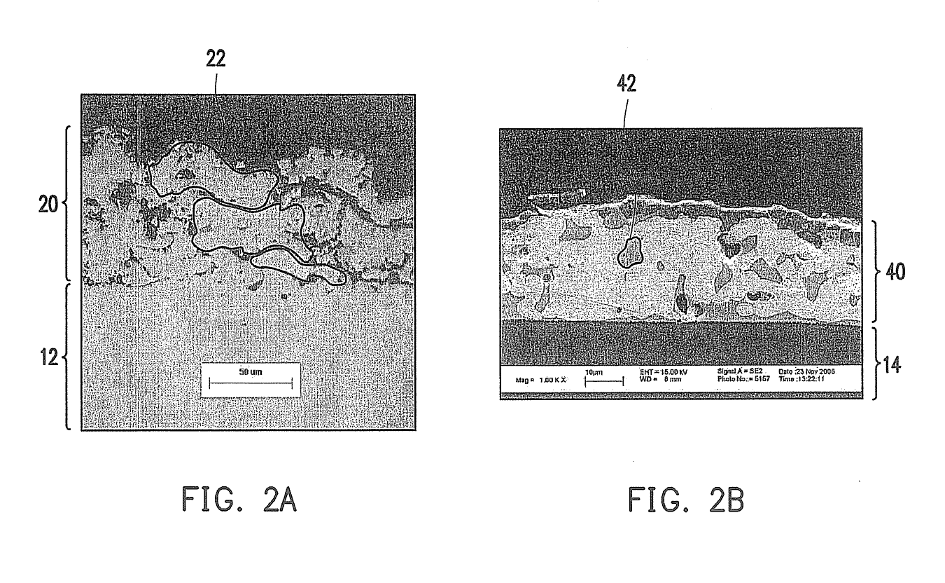

FIG. 2A and FIG. 2B are electron microscope photographs of coating layers respectively formed on substrates through the thermal spray method and the sintering method. According to FIG. 2A, it is know that a structure of a coating layer 20 formed on a substrate 12 through the thermal spray method is formed by a plurality of flat particles stacked on each other. Moreover, the substrate 12 is not influenced by a fabrication process. According to FIG. 2B, it is know that in a coating layer 40 formed on a substrate 14 through the sintering method, a particle 42 has a pattern that a boundary of the particle recess towards a center of the particle. Actually, due to the high temperature of the sintering process, an edge of the particle 42 has a diffusion phenomenon (for example, bulk diffusion, grain boundary diffusion, or surface diffusion, etc.). Namely, such high temperature may probably cause a similar diffusion phenomenon of the substrate 14 during the sintering process to change its original state.

Referring to FIG. 1, during the thermal spray process, the carrier 110 is unnecessary to be heated or baked, so as to avoid a damage caused by a heating process. Moreover, according to the thermal spray method, it is unnecessary to add a low melt point material such as lead to poison the food carried by the carrier 110. Therefore, a material of the high melt point-electric heating alloy pattern 120 is substantially lead-free, so as to avoid polluting the environment or the food. Moreover, the carrier 110 is not liable to be damaged due to a temperature of the thermal spray process, though a melt point of the high melt point-electric heating alloy pattern 120 is higher than or equal to 1100° C.

Moreover, besides a heating function provided by the carrier for heating and keeping warm 100, the food in the carrier 110 is required to be maintained at a certain temperature to facilitate eating at any time. Generally, a temperature of the food suitable for eating is preferably 50° C.-80° C. Therefore, a resistance of the high melt point-electric heating alloy pattern 120 is substantially 0.5 ohm to 50 ohm to achieve a specific heating limit.

For example, the material of the high melt point-electric heating alloy pattern 120 can be a metal alloy or a ceramics-metal alloy, which is, for example, a molybdenum alloy, a nickel-chromium alloy, a cobalt alloy, a nickel alloy, an iron alloy, a tungsten carbide-cobalt alloy or an alloy material formed based on the above alloys. These materials are not liable to be reacted with other matters and are not liable to be deteriorated, which avails prolonging a service life of the carrier for heating and keeping warm 100 using theses materials.

It should be noticed that a resistivity of theses materials is greater than that of silver, aluminium or copper, etc., so as to achieve a greater flexibility for resistance adjustment. For example, if a good conductor material, for example, silver, is required to reach a resistance of 50 ohm, in a pattern layout, a line width thereof has to be reduced and a line length thereof has to be increased. However, such layout method may increase a difficulty of the fabrication process. Therefore, the required resistance of the present exemplary embodiment can be easily achieved by using the alloy having greater resistivity.

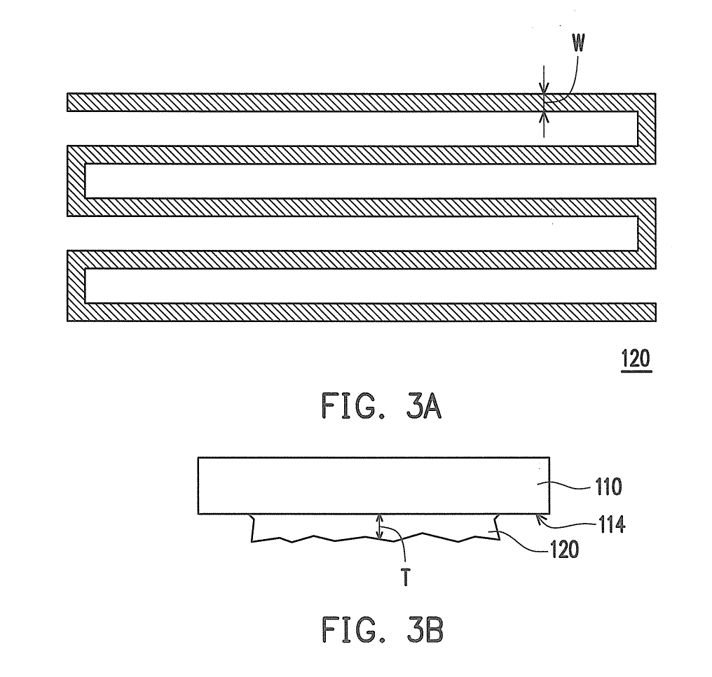

Since different patterns can be formed through the thermal spray method according to different requirements, in the present exemplary embodiment, the required resistance can be implemented according to a profile layout of the high melt point-electric heating alloy pattern 120. For example, FIG. 3A and FIG. 3B are respectively a top view of a high melt point-electric heating alloy pattern and a partial cross-sectional view of a carrier for heating and keeping warm according to an exemplary embodiment of the disclosure. Referring to FIG. 3A and FIG. 3B, the high melt point-electric heating alloy pattern 120 is, for example, a linear pattern, and a line width of the high melt point-electric heating alloy pattern 120 is greater than 3 mm.

Moreover, since the thermal spray method is used to form the high melt point-electric heating alloy pattern 120, a film thickness T of the high melt point-electric heating alloy pattern 120 can be suitably adjusted according to an actual fabrication requirement. For example, the film thickness T of the high melt point-electric heating alloy pattern 120 coated on the second surface 114 is 20 μm to 500 μm. According to such pattern layout, the resistance of the high melt point-electric heating alloy pattern 120 can fall within a range of 0.5 ohm to 50 ohm. Certainly, the above pattern layout is only used as an example, and actually the pattern layout of the high melt point-electric heating alloy pattern 120 can be adjusted and varied according to a selection of the material thereof and fabrication conditions of the thermal spray process.

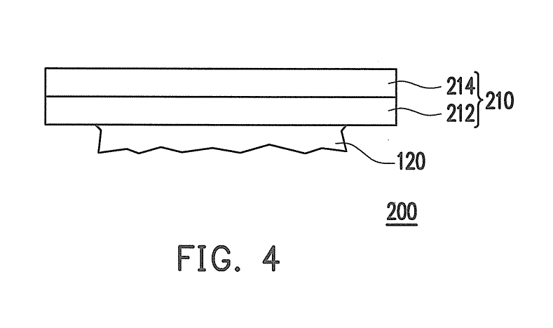

Moreover, the carrier 110 is not limited to be formed by a single type of material. FIG. 4 is a partial cross-sectional view of a carrier for heating and keeping warm according to another exemplary embodiment of the disclosure. Referring to FIG. 4, a carrier 210 of the carrier for heating and keeping warm 200 includes a first body 212 and a second body 214. In the present embodiment, the second body 214 can be made of metal or metal alloy. The second body 214 is closely attached to the first body 212. A material of the first body 212 is glass or ceramics and the high melt point-electric heating alloy pattern 120 is coated on the first body 212. For instance, the first body 212 can be formed on the second body 214 through a thermal spray method and the high melt point-electric heating alloy pattern 120 is formed on the first body 212 through another thermal spray method.

Namely, the carrier 210 can be a composite structure formed by different material layers, and the high melt point-electric heating alloy pattern 120 is configured on the first body 212 formed by glass or ceramics. Actually, in the present and the aforementioned exemplary embodiments, the glass material can be tempered glass, quartz glass, microcrystalline glass or crystal glass, and the ceramics material can be various ceramics materials suitable for containing the food.

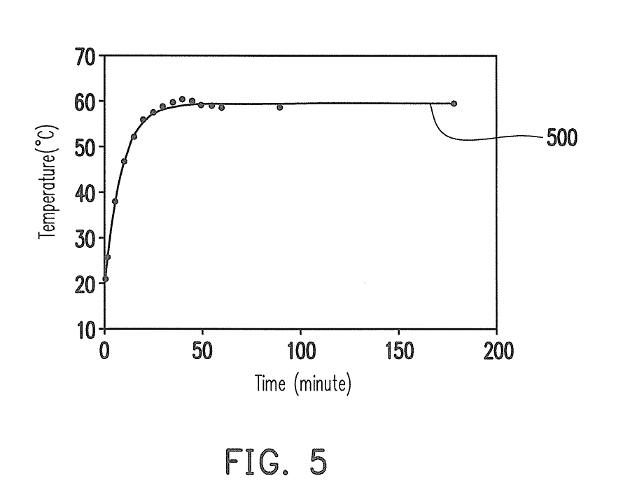

FIG. 5 is a diagram illustrating a heating curve of a powered carrier for heating and keeping warm according to an exemplary embodiment of the disclosure, in which a horizontal axis represents time, and a vertical axis represents temperatures. Referring to FIG. 5, in the carrier for heating and keeping warm of the present exemplary embodiment, molybdenum is used as the material of the high melt point-electric heating alloy pattern. Meanwhile, when the high melt point-electric heating alloy pattern is fabricated, the fabrication conditions of the arc spray method are that under a current of 170 A-200 A, a voltage of 25V-30V, and an air pressure of 60 psi.

In addition, the arc spray method is used for coating. In the present exemplary embodiment, the high melt point-electric heating alloy pattern is powered by direct current (DC) electricity of 120 W (for example, a voltage of 12V and a current of 10 A), and a heating state thereof is as that shown by a heating curve 500.

According to the heating curve 500, it is known that a heating limit of the high melt point-electric heating alloy pattern is about 60° C., so that the carrier for heating and keeping warm of the present exemplary embodiment can maintain a temperature of food around 60° C. Moreover, the carrier for heating and keeping warm of the present exemplary embodiment can heat the food by using a low power DC electricity, so as to avoid danger of using electricity.

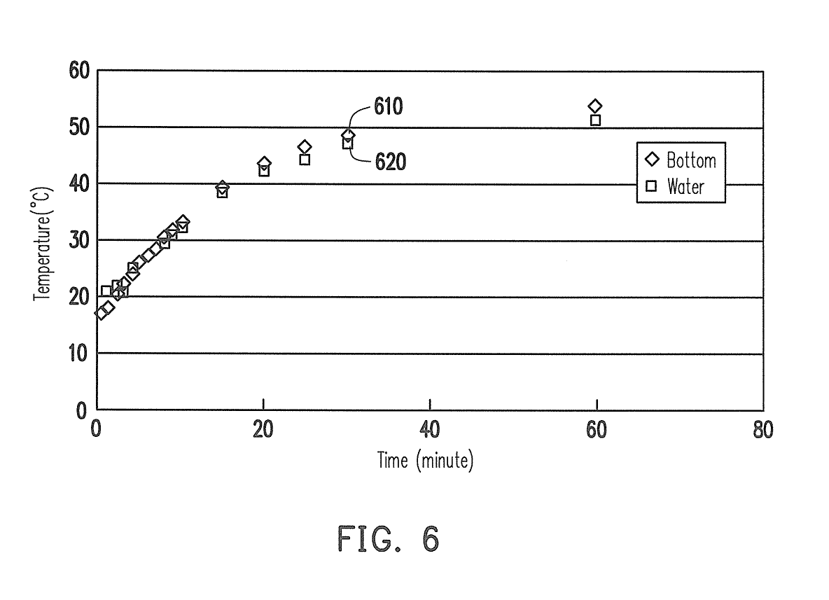

FIG. 6 is a diagram illustrating heating distributions of water and bottom of a powered carrier for heating and keeping warm in a water-carrying state according to an exemplary embodiment of the disclosure, in which a horizontal axis represents time, and a vertical axis represents temperatures. Referring to FIG. 6, in the carrier for heating and keeping warm of the present exemplary embodiment, the nickel-chromium alloy is used as the material of the high melt point-electric heating alloy pattern. Meanwhile, the carrier for heating and keeping warm carries water. The high melt point-electric heating alloy pattern of the present exemplary embodiment is powered by DC electricity of 120 W (for example, a voltage of 12V and a current of 10 A), and heating states of the bottom of the carrier and water carried by the carrier for heating and keeping warm are as that shown by heating distributions 610 and 620.

According to the heating distribution 610, in case that the water is carried, a heating limit of the high melt point-electric heating alloy pattern fabricated by the nickel-chromium alloy is about 50° C., so that the water in the carrier for heating and keeping warm can also be heated to a temperature of about 50° C. Moreover, the heating distribution 610 and the heating distribution 620 are highly correlated, which represents that the direct heating design of the present exemplary embodiment provides a desirable heating efficiency.

In summary, in the disclosure, a high melt point material is used, and the electric heating alloy pattern is directly foamed on the surface of the carrier used for carrying food according to the thermal spray method, so that the disclosure provides a carrier design capable of directly heating. Moreover, in the disclosure, by setting the resistance, the high melt point-electric heating alloy pattern may have a certain heating limit. Therefore, the carrier for heating and keeping warm of the disclosure can maintain the carried food at a certain temperature to facilitate eating at any time, so that the carrier for heating and keeping warm has a satisfactory utilization convenience. Moreover, regarding a material selection, the high melt point-electric heating alloy pattern is substantially lead-free so as to achieve environmental protection. Further, the high melt point-electric heating alloy pattern of the disclosure is fabricated according to the thermal spray method without using a high-temperature sintering method so as to avoid damaging the carrier due to the high-temperature sintering process.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A carrier for heating and keeping warm, for directly carrying food to be kept warm, the carrier for heating and keeping warm comprising:
a carrier, having a first surface and a second surface opposite to the first surface, wherein the food is directly placed on the first surface, and a material of the carrier is ceramics or glass; and
at least a high melt point-electric heating alloy pattern, coated on the second surface, wherein a resistance of the high melt point-electric heating alloy pattern is substantially 0.5 ohm to 50 ohm, and a melt point of the high melt point-electric heating alloy pattern is equal to or higher than 1100° C.

2. The carrier for heating and keeping warm as claimed in claim 1, wherein a material of the high melt point-electric heating alloy pattern comprises a metal alloy or a ceramics-metal alloy.

3. The carrier for heating and keeping warm as claimed in claim 1, wherein a material of the high melt point-electric heating alloy pattern comprises a molybdenum alloy, a nickel-chromium alloy, a cobalt alloy, a nickel alloy, an iron alloy or a tungsten carbide-cobalt alloy.

4. The carrier for heating and keeping warm as claimed in claim 1, wherein a material of the high melt point-electric heating alloy pattern is substantially lead-free.

5. The carrier for heating and keeping warm as claimed in claim 1, wherein the high melt point-electric heating alloy pattern is coated on the second surface according to a thermal spray method.

6. The carrier for heating and keeping warm as claimed in claim 5, wherein the thermal spray method comprises a plasma spray method, an arc spray method, a flame spray method or a high-speed flame spray method.

7. The carrier for heating and keeping warm as claimed in claim 1, wherein the high melt point-electric heating alloy pattern is a linear pattern, and a line width of the high melt point-electric heating alloy pattern is greater than 3 mm.

8. The carrier for heating and keeping warm as claimed in claim 1, wherein a film thickness of the high melt point-electric heating alloy pattern coated on the second surface is 20 μm to 500 μm.

9. The carrier for heating and keeping warm as claimed in claim 1, wherein the carrier comprises a first body and a second body, the second body is closely attached to the first body, a material of the first body is glass or ceramics, a material of the second body is metal or metal alloy, and the high melt point-electric heating alloy pattern is coated on the first body.

10. The carrier for heating and keeping warm as claimed in claim 1, wherein the carrier is a dish, a bowl, a pan, a cup or a platform.
